(19) United States
(12) Patent Application Publication
(10) Pub. No.: US 2016/0224965 A1
(43) Pub. Date: Aug. 4, 2016

(54) DETERMINING AN OPTIMAL PAYMENT INSTRUMENT BY A CLOUD-ENABLED MOBILE PAYMENT SERVICE

(71) Applicant: INTERNATIONAL BUSINESS MACHINES CORPORATION, Armonk, NY (US)

(72) Inventors: Deepak Chauhan, Noida (IN); Pranshu Tiwari, Dwaraka (IN); Saurabh Trehan, Delhi (IN)

(21) Appl. No.: 14/613,600

(22) Filed: Feb. 4, 2015

(51) Int. Cl. G06Q 20/22; G06Q 20/40; G06Q 20/36; G06Q 20/32

(52) U.S. Cl. CPC G06Q 20/227; G06Q 20/3278; G06Q 20/405; G06Q 20/363

(57) ABSTRACT

An approach is provided for determining an optimal payment instrument. A computer in a system configured in one of four predetermined cloud-based models updates a database with details about account balances and rewards provided by a customer's multiple accounts specifying payment instruments. A request is received from a near field communication enabled mobile device to purchase an item from a retailer. The request includes identifications of the retailer and the item. Based on the identifications, details about the account balances and rewards are retrieved from the database. Based on the details about the account balances and rewards, rules are applied and the optimal payment instrument is determined. A display of the optimal payment instrument to the customer is initiated. The optimal payment instrument is selected and a payment for the item by the optimal payment instrument is initiated.

### TECHNICAL FIELD

The present invention relates to managing a mobile payment, and more particularly to selecting an optimal payment instrument to make a mobile payment for a purchase of goods or services.

### BACKGROUND

Known mobile money services are successful in developing markets such as Kenya and Malaysia, whereas near field communication (NFC) and proximity based payments have not been leveraged to their potential in developed markets and high income emerging markets. The current mobile payment system is fragmented and various aggregators are not able to scale up their services for full-scale mass usage of NFC and proximity based payments. Furthermore, customers are satisfied with existing debit and credit payment instruments and have not been presented with a compelling reason to use NFC enabled wallet services.

Known mobile payment services such as U.S. Pat. No. 8,423,462 utilize a real time mobile wallet server that receives a user's request for a transaction with an entity and then displays all available payment options to the user. The payment options include a list of payment types that includes multiple credit and debit payment card selections that user had stored in the wallet server prior to the transaction. The user selects from the list of payment types to indicate the payment instrument to be used to complete the transaction.

### BRIEF SUMMARY

In a first embodiment, the present invention provides a method of determining an optimal payment instrument. The method includes a cloud-based computer updating a database with details about rewards provided by multiple accounts of a customer. The accounts specify respective payment instruments. The method further includes the computer receiving a request from a near field communication enabled mobile device to purchase an item from a retailer. The request includes an identification of the retailer and an identification of the item. The method further includes based on the identifications of the retailer and the item, the computer retrieving the details about the rewards from the periodically updated database. The method further includes based on the retrieved details about the rewards provided by the multiple accounts specifying the payment instruments, the computer applying rules. The method further includes in response to the step of applying the rules, the computer determining the optimal payment instrument from among the payment instruments. The method further includes the computer initiating a display of the optimal payment instrument to the customer. The method further includes the computer automatically selecting the displayed optimal payment instrument or receiving a manual selection of the displayed optimal payment instrument. The method further includes in response to the step of selecting or receiving the selection, the computer initiating a payment for the item by the optimal payment instrument.

In a second embodiment, the present invention provides a computer program product including a computer-readable storage device and a computer-readable program code stored in the computer-readable storage device. The computer-readable program code includes instructions that are executed by a central processing unit (CPU) of a computer system to implement a method of determining an optimal payment instrument. The method includes a cloud-based computer system periodically updating a database with details about rewards provided by multiple accounts of a customer. The accounts specify respective payment instruments. The method further includes the computer system receiving a request from a near field communication enabled mobile device to purchase an item from a retailer. The request includes an identification of the retailer and an identification of the item. The method further includes based on the identifications of the retailer and the item, the computer system retrieving the details about the rewards from the periodically updated database. The method further includes based on the retrieved details about the rewards provided by the multiple accounts specifying the payment instruments, the computer system applying rules. The method further includes in response to the step of applying the rules, the computer system determining the optimal payment instrument from among the payment instruments. The method further includes the computer system initiating a display of the optimal payment instrument to the customer. The method further includes the computer system automatically selecting the displayed optimal payment instrument or receiving a manual selection of the displayed optimal payment instrument. The method further includes in response to the step of selecting or receiving the selection, the computer system initiating a payment for the item by the optimal payment instrument.

In a third embodiment, the present invention provides a computer system including a central processing unit (CPU); a memory coupled to the CPU; and a computer-readable storage device coupled to the CPU. The storage device includes instructions that are executed by the CPU via the memory to implement a method of determining an optimal payment instrument. The method includes a cloud-based computer system periodically updating a database with details about rewards provided by multiple accounts of a customer. The accounts specify respective payment instruments. The method further includes the computer system receiving a request from a near field communication enabled mobile device to purchase an item from a retailer. The request includes an identification of the retailer and an identification of the item. The method further includes based on the identifications of the retailer and the item, the computer system retrieving the details about the rewards from the periodically updated database. The method further includes based on the retrieved details about the rewards provided by the multiple accounts specifying the payment instruments, the computer system applying rules. The method further includes in response to the step of applying the rules, the computer system determining the optimal payment instrument from among the payment instruments. The method further includes the computer system initiating a display of the optimal payment instrument to the customer. The method further includes the computer system automatically selecting the displayed optimal payment instrument or receiving a manual selection of the displayed optimal payment instrument. The method further includes in response to the step of selecting or receiving the selection, the computer system initiating a payment for the item by the optimal payment instrument.

Embodiments of the present invention provide cloud-based analytics and rule engine to enable customers to make an informed decision in selecting an optimal payment instrument for the purchase of goods and services. Embodiments of the present invention allow customers to select the optimal payment instrument by using a single sign-on technique to obtain near real time data exchange from different accounts of the customers with the permission of a trusted service manager or regulatory authority. Embodiments of the present invention provide business models by which banks, information technology (IT) service providers, and telcos (i.e., telecommunications service providers or mobile network operators (MNOs)) and other ecosystem partners (e.g., retailers, government agencies, etc.) can more easily collaborate and scale up the existing infrastructure to a large scale implementation of mobile payment services.

Embodiments disclosed herein provide the following advantages: (1) enablement of business innovation by an addition of new partners with a cost and revenue option; (2) minimal upfront investment and reduced operational risk; (3) a distribution of investments across multiple parties through a shared infrastructure; (4) minimized cost of investment on cloud infrastructure services; (5) a business-to-business (B2B) opportunity by providing cloud services to telcos to be market leaders; and (6) effective response to changing customer and regulatory requirements.

### BRIEF DESCRIPTION OF THE DRAWINGS

FIG. 1 is a block diagram of a system for determining an optimal payment instrument, in accordance with embodiments of the present invention.

FIG. 2 is a flowchart of a process of determining an optimal payment instrument, where the process is implemented in the system of FIG. 1, in accordance with embodiments of the present invention.

FIG. 3 is a block diagram of value components of the system of FIG. 1 configured as a smart wallet as a service model, where the cloud provider and the cloud user are different entities, in accordance with embodiments of the present invention.

FIG. 4 is a block diagram of value components of the system of FIG. 1 configured as a smart wallet as a service model, where a telco is both the cloud provider and the cloud user, in accordance with embodiments of the present invention.

FIG. 5 is a block diagram of value components of the system of FIG. 1 configured as a smart wallet in a box model, in accordance with embodiments of the present invention.

FIG. 6 is a block diagram of value components of the system of FIG. 1 configured as a smart wallet hub and spoke model, in accordance with embodiments of the present invention.

FIG. 7 is a block diagram of value components of the system of FIG. 1 configured as a smart wallet aggregator model, where the cloud provider and telco are different entities, in accordance with embodiments of the present invention.

FIG. 8 is a block diagram of value components of the system of FIG. 1 configured as a smart wallet aggregator model, where the telco is the cloud provider, in accordance with embodiments of the present invention.

FIG. 9 is a block diagram of a computer that provides cloud-based services in the system of FIG. 1 and that implements the process of FIG. 2, in accordance with embodiments of the present invention.

### DETAILED DESCRIPTION

### Overview

Embodiments of the present invention provide a cloud-enabled smart wallet service (i.e., mobile payment service) that utilizes a business intelligence component that runs analytics to determine an optimal payment instrument (i.e., debit card, credit card, voucher, gift card, or other payment instrument) for a purchase transaction and present the optimal payment instrument to a customer at the point of sale (POS). The customer selects the optimal payment instrument from multiple possible payment instruments so that the customer receives or maximizes a financial or monetary reward or other benefit resulting from completing the transaction with the selected payment instrument. To enable the determination of the optimal payment instrument, a cloud-based single-sign on component allows data from different accounts of the customer to be aggregated and obtained with permission from a trusted service manager or regulatory authority. Embodiments presented herein may implement a mobile payment system by utilizing one of the following business models: smart wallet as a service, smart wallet in a box, smart wallet hub and spoke, and smart wallet aggregator. The business models are derived by deconstructing the smart wallet value chain and identifying components that could be moved or benefited by cloud-based delivery. As used herein, a reward is defined as a discount, voucher, cashback incentive, merchandise, gift card, loyalty points, or other benefit or incentive having a monetary value, which is received by a customer for completing a transaction with a particular payment instrument.

### System for Determining an Optimal Payment Instrument

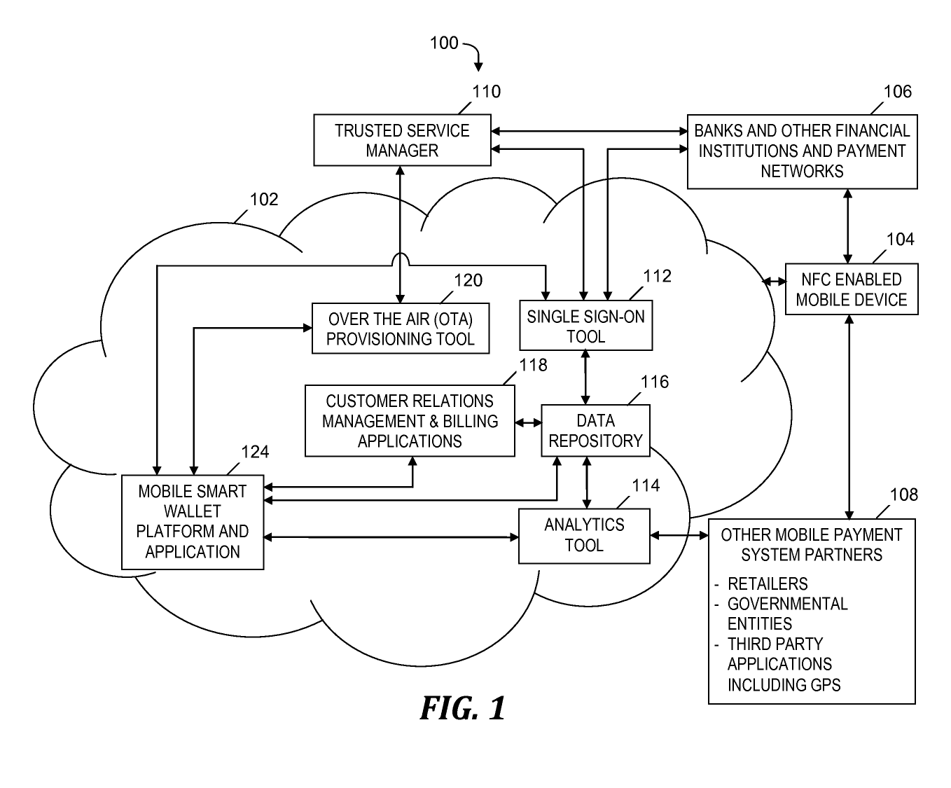

FIG. 1 is a block diagram of a system 100 for determining an optimal payment instrument, in accordance with embodiments of the present invention. System 100 includes a cloud computing environment 102, a NFC enabled mobile device 104, computer systems 106 of banks, other financial institutions, and payment networks, computer systems 108 of other mobile payment system partners (i.e., retailers, governmental entities, and third party applications including global positioning system (GPS)), and a computing system of a trusted service manager (TSM). The aforementioned banks, other financial institutions, payment networks, retailers, governmental entities (e.g., transportation, electricity, rail, etc.), third party applications and the TSM are referred to herein collectively as ecosystem partners.

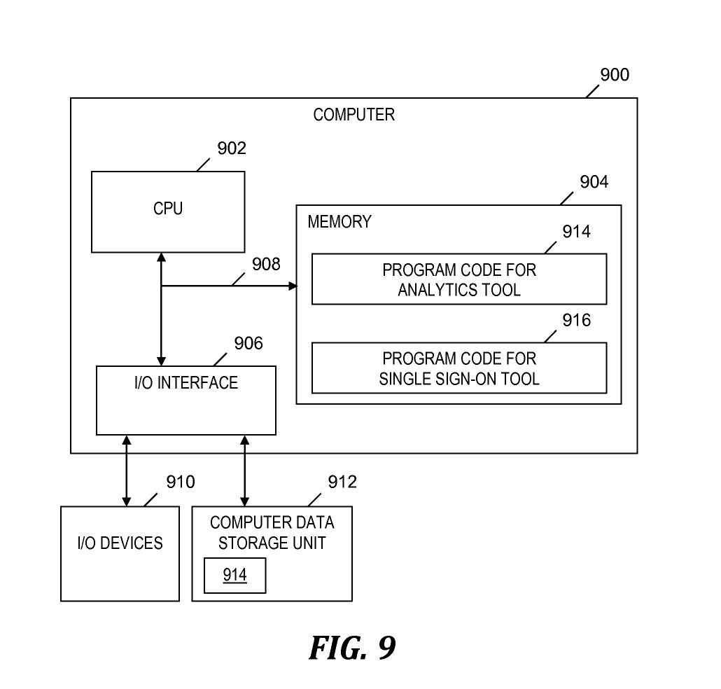

Cloud computing environment 102 includes a network of interconnected nodes (not shown), including cloud computing node 900 (not shown in FIG. 1; see FIG. 9), which includes software-based components single sign-on (SSO) tool 112 and analytics tool 114, data repository 116, and software-based components customer relations management (CRM) and billing applications 118, over the air (OTA) provisioning tool 120, and mobile smart wallet platform and application 124. Cloud computing environment 102 provides service delivery for enabling convenient, on-demand network access to a shared pool of configurable computing resources (e.g., servers, processing, memory, storage, applications, and services) that can be rapidly provisioned and released with minimal management effort or interaction with a provider of the service.

Mobile smart wallet platform and application 124 is a platform that supports functionalities for mobile device-based commerce and banking, and that stores details of multiple mobile wallets (also known as (a.k.a.) smart wallets).

Data repository 116 includes a near real time database that captures and stores details of multiple accounts of different financial institutions for multiple customers. Each customer may have one or more than one of the accounts. The details stored in the near real time database include each customer's usage of credit and/or debit cards. The details further include the current monetary funds in bank accounts of customers, where the funds in an account are available to a corresponding customer for purchasing an item or service. The capture of the details is triggered every X minutes (e.g., 15 minutes), where is X is a specified amount of time which is received by cloud computing environment 102. Data repository 116 also includes a database that captures and stores details about rewards (e.g., loyalty points, discount, and voucher data) that are available to respective customers. The database of rewards details is updated on demand by a user or is triggered on a monthly or other periodic basis.

Mobile smart wallet platform and application 124 sends triggers to run a script in the near real time database in data repository 116 to update customer account information through an SSO feature of SSO tool 112, which fetches the account information from (1) a regulatory authority with the permission of TSM 110 (in the case in which the regulatory authority has the data in the customer accounts) or (2) directly from respective banks and other financial institutions with the permission of TSM 110 (in the case in which the regulatory authority does not have the data in the customer accounts). being updated is the banks and other financial institutions and payment networks 106 and retailers and merchants in the other mobile payment system partners 108 through a single sign-on (SSO) feature provided by single sign-on tool 112, so that analytics tool 114 receive via trusted service manager 110 the near real time balance information on cards and vouchers that are enrolled or registered in the smart wallets of customers. Mobile smart wallet platform and application 124 sends the trigger so that the customer account information is captured every X minutes, where X is a configurable amount of time (e.g., every 15 minutes) to reflect the real time information in the smart wallets. In a known mobile wallet system, an SSO feature is used differently from the embodiments disclosed herein. The SSO feature in the known mobile wallet system is activated only in response to a user manually selecting one particular card or other payment instrument when tapping at a point-of-sale terminal to login into a merchant account, which results in money being debited immediately from the account of the selected card or other payment instrument when the transaction is completed.

Analytics tool 114 (i.e., business intelligence engine) is a cloud-based business intelligence component that analyzes the usage of the card, loyalty points, discounts, vouchers, and current available funds (e.g., current bank balance) from data repository 116 and customer consumption information from CRM and billing applications 118 to identify an optimal payment instrument from among multiple potential payment instruments of a customer to make a payment for an item or a service. The customer utilizes the identified optimal payment instrument to make an informed decision about the usage and selection of a correct payment instrument (e.g., credit card or debit card) for a particular payment.

OTA provisioning tool 120 provisions bank details on secured elements of mobile devices, where a secured element includes a universal integrated circuit card (UICC) or an embedded chip which embeds various applications and essential data through a secured application hosted over the secured element. The provisioning of services on cloud computing environment 102 is performed by a telco with permission of the TSM. The TSM is a neutral broker that sets up business agreements and technical connections with telcos, telephone manufacturers, and other entities controlling the secure elements on mobile devices.

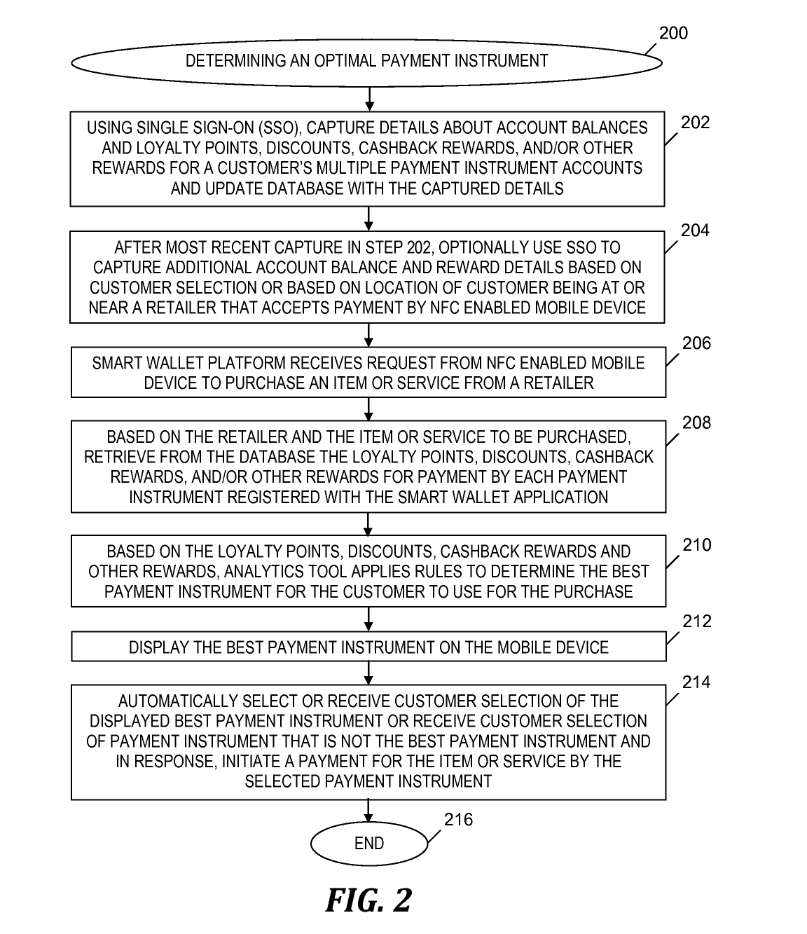

The functionality of the components of FIG. 1 is described in more detail in the discussions presented below relative to FIG. 2 and FIG. 9.

### Process for Determining an Optimal Payment Instrument

FIG. 2 is a flowchart of a process of determining an optimal payment instrument, where the process is implemented in the system of FIG. 1, in accordance with embodiments of the present invention. The process of FIG. 2 starts at step 200. Prior to step 202, mobile smart wallet platform and application 124 (see FIG. 1) registers information about payment instrument accounts of multiple customers, where each customer has multiple accounts that specify payment instruments such as credit cards and debit cards.

In step 202, mobile smart wallet platform and application 124 (see FIG. 1) automatically and periodically (e.g., every 15 minutes) generates an interrupt signal and sends the signal to the near real time database in data repository 116 to run a script to update customer account information in the near real time database through the SSO feature of SSO tool 112. The running of the script fetches the customer account information from (1) a regulatory authority with the permission of TSM 110 (see FIG. 1) (in countries in which the regulatory authority has all the relevant customer account information, and in which case the regulatory authority obtains the customer account information from banks and other financial institutions on a near real time basis) or (2) directly from respective banks and other financial institutions with the permission of TSM 110 (see FIG. 1) (in countries in which the regulatory authority does not have the customer account information). In step 202 or in another step (not shown) prior to step 204, mobile smart wallet platform and application 124 (see FIG. 1) utilizes the SSO feature of single sign-on tool 112 (see FIG. 1) to query and capture rewards details from retailers in other mobile payment system partners 108 (see FIG. 1) on an on demand basis or on a monthly (or other periodic) basis. Reward details include information about loyalty points, discounts, vouchers, cashback rewards, and other rewards specified by a customer's payment instrument accounts. Mobile smart wallet platform and application 124 (see FIG. 1) stores the reward details in data repository 116 (see FIG. 1).

In step 204, mobile smart wallet platform and application 124 (see FIG. 1) utilizes GPS inputs to determine geographic locations of customers and determine whether any of the locations of the customers match locations of retailers. If a location of a customer matches the location of a retailer, mobile smart wallet platform and application 124 (see FIG. 1) generates and sends a GPS enabled interrupt signal to data repository 116 (see FIG. 1) to query and capture (1) all the associated account balance details from banks and other financial institutions and payment networks 106, in addition to the customer account information fetched in step 202, and (2) additional rewards details from retailers in other mobile payment system partners 108, using the SSO feature of single sign-on tool 112 (see FIG. 1). Analytics tool 114 (see FIG. 1) receives the associated account balance details from trusted service manager 110 (see FIG. 1). Analytics tool 114 (see FIG. 1) updates data repository 116 (see FIG. 1) by storing the associated account balance details and the additional reward details in database(s) or other data structure(s) in data repository 116 (see FIG. 1). The updated data repository 116 is updated subsequent to the most recent update from the periodic update in step 202.

In one embodiment, step 204 includes analytics tool 114 (see FIG. 1) receiving a location of a customer by receiving GPS input from NFC enabled mobile device 104 (see FIG. 1) and retrieving from data repository 116 (see FIG. 1) location information and payment information about retailer(s) and in response to retrieving the location and payment information, determining the retailer(s) are located within a threshold distance from the location of the customer and determining the retailer(s) accept payment from a mobile device enabled with an NFC feature. Based on the retailer(s) being located within the threshold distance from the location of the customer and based on the retailer(s) accepting payment from a mobile device enabled with an NFC feature, analytics tool 114 (see FIG. 1) determines whether a reward provided by one of the multiple accounts of the customer requires a purchase from one of the retailer(s). If the reward requires the purchase from one of the retailer(s), analytics tool 114 (see FIG. 1) updates data repository 116 (see FIG. 1) with additional details about the reward subsequent to the most recent periodic update of data repository 116 (see FIG. 1) by step 202 and sends a notification to the customer of the additional details about the reward.

In one embodiment, step 204 includes a customer making a selection on an interface of NFC enabled mobile device 104 (see FIG. 1) to use the SSO feature of single sign-on tool 112 (see FIG. 1) to perform an on demand update of the account balance and/or reward details stored in data repository 116 (see FIG. 1), where the update occurs subsequent to the most recent update of data repository 116 (see FIG. 1) described in step 202.

In another embodiment, step 204 is eliminated and step 202 is followed by step 206.

In step 204, the mobile smart wallet application 124 (see FIG. 1) sends mobile smart wallet account details to the data repository 116 (see FIG. 1).

In step 206, a customer opens a smart wallet application via a front end widget which is connected to mobile smart wallet platform and application 124 (see FIG. 1), and in response, mobile smart wallet platform and application 124 (see FIG. 1) receives a request from NFC enabled mobile device 104 (see FIG. 1) to purchase an item or service from a retailer. The request includes an identification of the retailer and an identification of the item or service being purchased.

In step 208, based on the identifications of the retailer and the item or service to be purchased, analytics tool 114 retrieves from data repository 116 (see FIG. 1) the loyalty points, discounts, vouchers, cashback rewards, and other rewards for payment by each payment instrument registered with the smart wallet mobile smart wallet platform and application 124 (see FIG. 1).

In step 210, based on the loyalty points, discounts, vouchers, cashback rewards, and other rewards for payment by each payment instrument of the customer who is making the purchase, analytics tool 114 (see FIG. 1) applies rules to determine the optimal payment instrument for the customer to use for the purchase of the item or service. In one embodiment, the optimal payment instrument is the payment instrument that provides a discount or cashback or other reward(s) that effectively maximizes a discount of the price of the item or service being purchased or otherwise having the greatest monetary value to the customer. In another embodiment, the optimal payment instrument is the payment instrument that provides an amount of loyalty points that when added to previously earned loyalty points, reaches a predetermined level of loyalty points that was specified by the customer as being sufficient to obtain or facilitate the obtaining of a particular item or service (i.e., different from the item or service being purchased) as a benefit which the customer considers to have more value than other reward(s) that effectively discount the price of the item or service being purchased, where the other reward(s) are being offered if the customer uses payment instrument(s) other than the optimal payment instrument.

In step 212, mobile smart wallet platform and application 124 (see FIG. 1) initiates a display of the optimal payment instrument on the NFC enabled mobile device 104 (see FIG. 1). In one embodiment, the display of the optimal payment instrument includes details about the reward(s) associated with making the payment for the item or service by using the optimal payment instrument.

In step 214, mobile smart wallet platform and application 124 (see FIG. 1) (1) automatically selects or receives a selection from the customer of the displayed optimal payment instrument, or (2) receives a selection from the customer of a payment instrument that is not the optimal payment instrument. In response to selecting or receiving the selection of the optimal payment instrument or receiving the selection of another payment instrument that is not the optimal instrument, mobile smart wallet platform and application 124 (see FIG. 1) initiates a payment for the item or service by the optimal payment instrument if the optimal payment instrument has been selected, or by the other payment instrument if the other payment instrument has been selected by the customer. The process of FIG. 2 ends at step 216.

Provisioning methods used by system 100 (see FIG. 1) include:

(1) With the help of TSM 110 (see FIG. 1), a telco provisions the chip or Secure Element (SE) of an NFC enabled mobile device with bank details and customer details, which differ from other bank codes on the same chip or SE.

(2) A telco on behalf of TSM 110 (see FIG. 1) provisions the card or chip of the NFC enabled mobile device for payment purposes.

(3) Coupons are loaded in the Universal Integrated Circuit Card (UICC) chip of the NFC enabled mobile device.

### Models

The four models discussed in this section are the smart wallet as a service, smart wallet in a box, smart wallet hub and spoke, and smart wallet aggregator models. The four models are based on different divisions of smart wallet value chain components and key responsibilities among ecosystem partners. Each model has its own pre-requisites, key core capabilities, and benefits which allow telecommunications companies to deliver smart wallet services over the cloud platform. The models are designed to primarily be adopted in developed countries and rich populations in emerging markets where telecommunications companies and other ecosystem partners can reap significant benefits and earn revenues.

The smart wallet as a service model enables a telco to provide smart wallet services to other telcos or to the telco's customers directly. Alternatively, a telco can leverage smart wallet as a service from cloud providers (i.e., cloud service providers) to bring about IT efficiency and cost innovation. Ecosystem partners such as retailers can leverage smart wallet as a service for enhanced customer support for payments which facilitate customer growth. In the smart wallet as a service model, the cloud provider manages customer accounts and acts as a proxy banker for mobile wallet customers. The cloud provider owns the mobile money platform over the cloud and provisions different ecosystem partners for use of the smart wallet services, after approval of TSM 110 (see FIG. 1). The cloud provider owns the OTA platform which is used for application loading and personalization. TSM 110 (see FIG. 1) pre-authorizes the cloud provider and cloud user to configure secured information of customers.

Telcos, banks and IT companies can adopt the smart wallet as a service model, but need to acquire key business capabilities as the cloud provider, including (1) cloud delivery infrastructure to deliver cloud services including mobile money platform to users; (2) cloud based account management; (3) banking license; (4) smart wallet lifecycle management and support (i.e., OTA provisioning of multiple cards and ecosystem partners' applications on SIM and smart phones, and taking authorization from TSM 110 (see FIG. 1) loading application service domain and personalization of credit cards; and (5) ownership of the mobile wallet platform services on the cloud, which can be used by other users, too.

Cloud service providers in the smart wallet as a service model obtain revenue from account opening fees, network connectivity charges, premium charges from banks and ecosystem partners for card creation one-time provisioning charges for cloud users. In one embodiment, the revenue (i.e., R) of a cloud service provider in the smart wallet as a service model is calculated by formula (1), which is the summation of different revenue sources:

R(Cloud Provider)=f(μA, Ii, U, βP, NPh, Bφ, c, t, T)=ΣA*μ*U+ΣIi*U+Σβ*P*N+ΣPh*B+Σc*φ+Σt*T*U (1)

Formula (2) calculates the total cost (i.e., Cost) required to acquire the key business capabilities, which are discussed above.

Cost=f(ΔC)=Cost to inherit new capabilities (2)

Formula (3) determines the revenue (i.e., R) of cloud users who leverage the smart wallet service from cloud providers minimizing upfront investment, reducing operational risk, and providing services to customers.

R(Cloud user)=Σ(1−μ)A+t*T*U+(1−β)N (3)

If a telco is the cloud provider in a smart wallet as a service model and the telco is providing smart wallet services directly to its customers, the total indicative revenue (i.e., R) is shown in formula (4):

R=ΣA*U+ΣIi*U+ΣP*N+Ph*B+t*T*U (4)

The symbols used in formulas (1) through (4) above are described below:

R=Revenue

A=Account opening fees

μ=Percent sharing of account fees between cloud user and cloud provider

U=Customers per telco

Ii=Interest of holding money in bank for telco per customer

P=Premium charges from banks or retailers for creation of additional card and voucher

β=Sharing charges for provisioning cards between cloud user and cloud provider

Ph=One-time provisioning charge to enable platform to be used by cloud user

B=Number of cloud users

N=Number of ecosystem partners

c=One-time charge from the retailer

T=Transaction charges

t=Number of transactions per customer

φ=Revenue shared between TSM and cloud provider

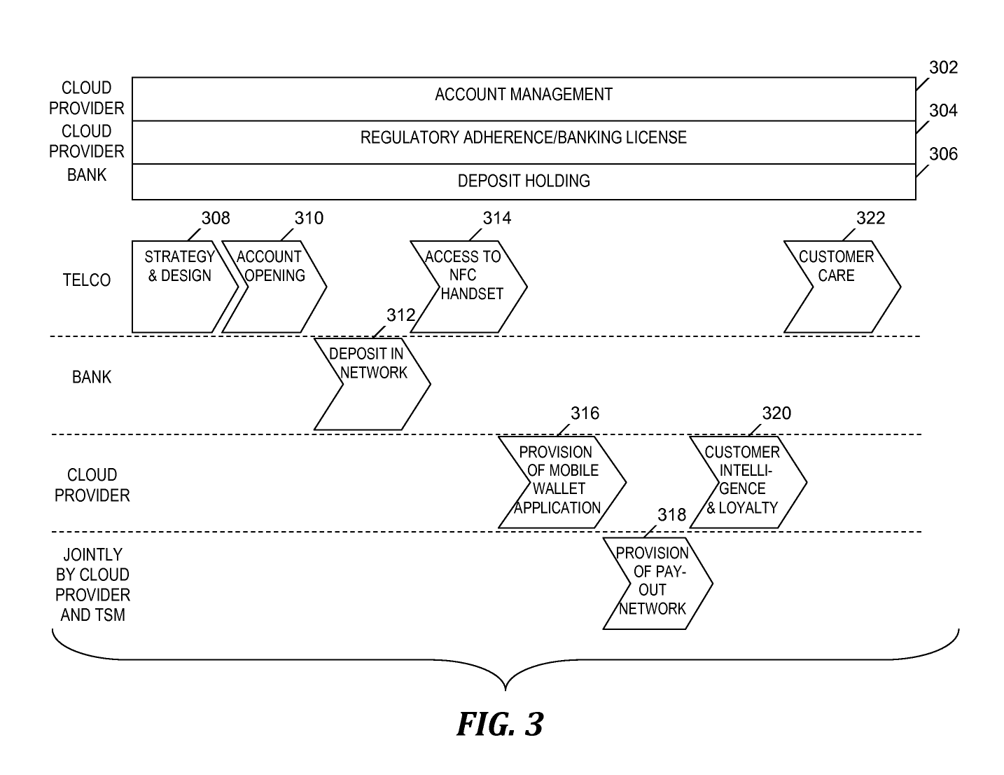

FIG. 3 is a block diagram of value components of system 100 in FIG. 1 configured as a smart wallet as a service model, where a cloud provider and the cloud user are different entities, in accordance with embodiments of the present invention. The cloud provider provides the services of cloud computing environment 102 (see FIG. 1) and manages account management 302 and regulatory adherence and banking license 304. A bank included in banks and other financial institutions 106 (see FIG. 1) manages deposit holding 306. A telco manages strategy and design 308 and account opening 310. The bank manages a deposit in network 312. The telco manages an access to an NFC handset 314. The cloud provider manages a provision of a mobile wallet application 316. The cloud provider and TSM 110 (see FIG. 1) jointly manage a provision of a pay-out network 318. The cloud provider manages customer intelligence and loyalty 320. The telco manages customer care 322.

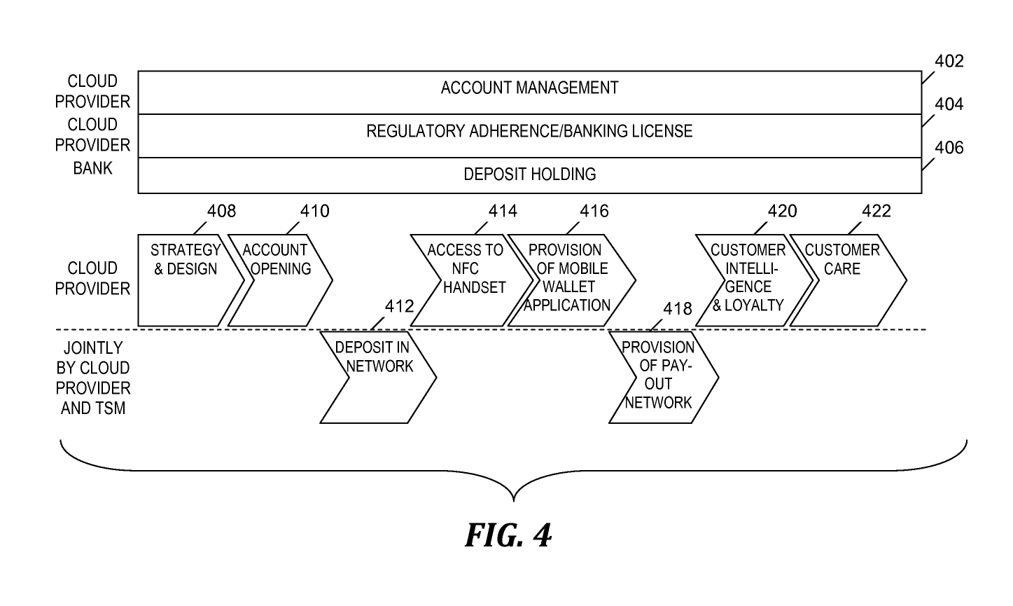

FIG. 4 is a block diagram of value components of system 100 in FIG. 1 configured as a smart wallet as a service model, where a telco is both the cloud provider and the cloud user, in accordance with embodiments of the present invention. The cloud provider that is a telco provides the services of cloud computing environment 102 (see FIG. 1) and manages account management 402 and regulatory adherence and banking license 404. A bank included in banks and other financial institutions 106 (see FIG. 1) manages deposit holding 406. The cloud provider manages strategy and design 408 and account opening 410. The cloud provider and TSM 110 (see FIG. 1) jointly manage a deposit in network 412. The cloud provider manages an access to an NFC handset 414 and a provision of a mobile wallet application 416. The cloud provider and TSM 110 (see FIG. 1) jointly manage a provision of a pay-out network 418. The cloud provider manages customer intelligence and loyalty 420 and customer care 422.

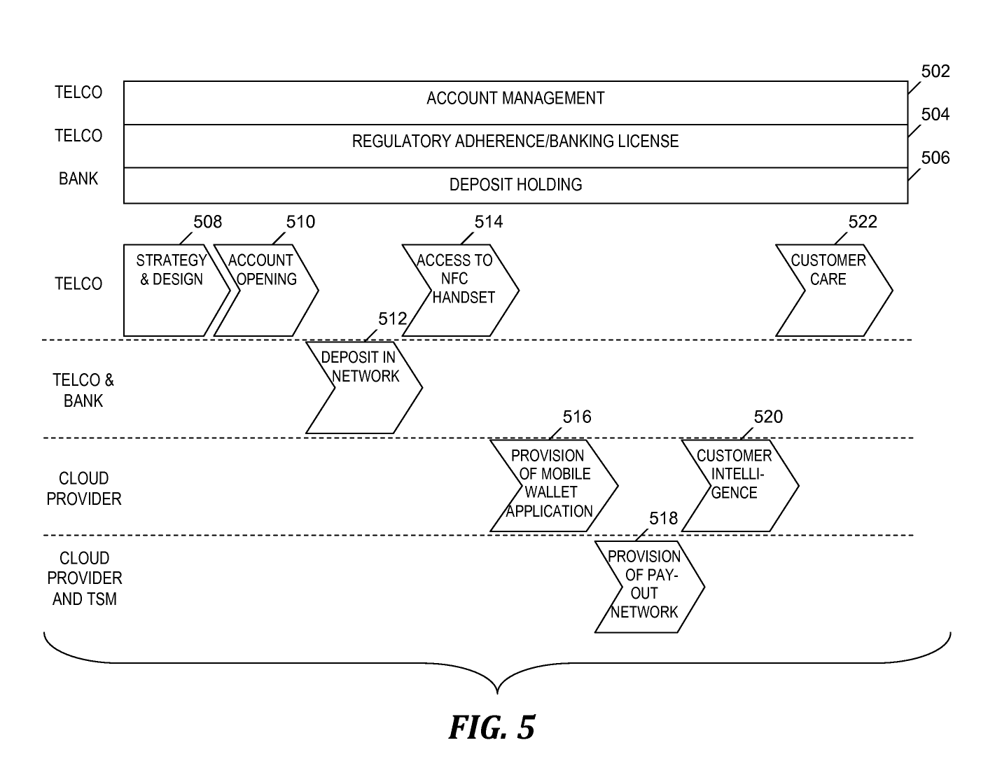

FIG. 5 is a block diagram of value components of the system of FIG. 1 configured as a smart wallet in a box model, in accordance with embodiments of the present invention. Smart wallet in a box is a configured plug and play cloud service that telco companies adopt as users to enable the telco companies to provide smart wallet as a service to the telco companies' customers. IT companies are best aligned to be cloud providers in the smart wallet in a box model. Telco companies that are providing smart wallet as a service can move into the smart wallet in a box model in geographical regions in which the telco companies do not have a banking license, thereby leveraging their cloud infrastructure to provide the smart wallet in a box services to other telco companies.

A telco manages account management 502 and regulatory adherence and banking license 504. A bank included in banks and other financial institutions 106 (see FIG. 1) manages deposit holding 506. The telco manages strategy and design 508 and account opening 510. The telco and the bank jointly manage a deposit in network 512. The telco manages an access to an NFC handset 514. The cloud provider manages a provision of a mobile wallet application 516. The cloud provider and TSM 110 (see FIG. 1) jointly manage a provision of a pay-out network 518. The cloud provider manages customer intelligence 520. The telco manages customer care 522.

Unlike in a smart wallet as a service model, the cloud user (i.e., telco) in the smart wallet in a box model owns account management, account opening, and deposit in network. The cloud provider provides cloud services for payment application, business analytics, infrastructure, and provision of payout networks. After authorization by TSM 110 (see FIG. 1), the cloud provider loads the application security domain (ASD) and personalization of the application over the telco network.

The cloud provider, which is a telco in the smart wallet in a box model, provides the services of cloud computing environment 102 (see FIG. 1) and manages account management 402 and regulatory adherence and banking license 404. A bank included in banks and other financial institutions 106 (see FIG. 1) manages deposit holding 406. The cloud provider, which is the telco, manages strategy and design 408 and account opening 410. The cloud provider and TSM 110 (see FIG. 1) jointly manage a deposit in network 412. The cloud provider manages an access to an NFC handset 414 and a provision of a mobile wallet application 416. The cloud provider and TSM 110 (see FIG. 1) jointly manage a provision of a pay-out network 418. The cloud provider manages customer intelligence and loyalty 420 and customer care 422.

A telco providing smart wallet as a service can adopt the smart wallet in a box model in countries in which the telco does not have a banking license. IT companies can adopt smart wallet in box model provided the IT companies have a cloud delivery infrastructure, a mobile money platform, and an OTA platform tool.

Cloud service providers in the smart wallet in a box model obtain revenue from account opening fees, network connectivity charges, premium charges from banks and ecosystem partners for card creation one-time provisioning charges for cloud users. In one embodiment, the revenue (i.e., R) of a cloud service provider in the smart wallet in a box model is calculated by formula (5), which is the summation of different revenue sources:

R(Cloud Provider)=f(Li, B, Ph)=ΣLi+ΣPh*B (5)

The symbols in formula (5) are described below.

Li=Licensing fees per 1000 wallets

Ph=One-time provisioning charges to enable the platform to be used by a cloud user

B=Number of cloud users

Formula (6) is an indicative formula that calculates the total cost (i.e., Cost) required to acquire the key business capabilities, which are required by ecosystem partners to adopt the smart wallet in a box model. The key business capabilities are discussed above.

Cost=f(ΔC)=Cost to inherit new capabilities (6)

Formula (7) determines the revenue (i.e., R) of cloud users who leverage the smart wallet service from cloud providers minimizing upfront investment, reducing operational risk, and providing services to customers.

R(Clouduser)=ΣA*U+t*T*U+Ii*U (7)

The symbols used in formula (7) is described below:

R=Revenue

A=Account opening fees

U=Customers per telco

Ii=Interest of holding money in bank

T=Transaction fees

t=Number of transactions/customer

N=Number of ecosystem partners

P=Provisioning fees

In one embodiment, the process flow of actions by the customer, telco, cloud provider, TSM, and other ecosystem partners in a smart wallet in a box model in which the plug and play device is owned by the cloud provider who does not have a banking license includes the following steps:

(1) The customer places a request to open the smart wallet.

(2) The telco opens the smart wallet account.

(3) The telco allocates NFC handsets to customers.

(4) The customer receives the NFC handsets.

(5) The customer requests OTA provisioning using Short Message Service (SMS) or Unstructured Supplementary Service Data (USSD).

(6) The cloud provider processes the customer request OTA. The telco owns the mobile money platform over the cloud.

(7) TSM grants approval.

(8) The cloud provider performs application loading and personalization of the application.

(9) The customer selects a product service and initiates a payment transaction.

(10) The telco initiates a payment request and connects to a payment network.

(11) In response to OTA information flow using SMS or USSD from the telco to other ecosystem partners, the payment transaction is completed.

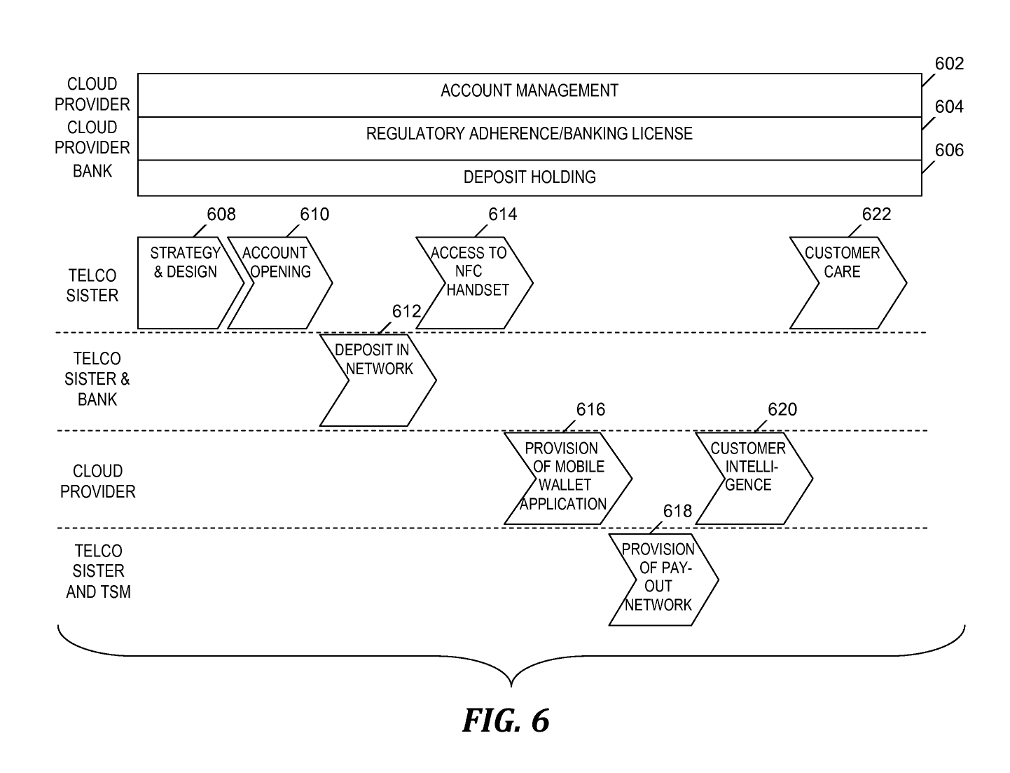

FIG. 6 is a block diagram of value components of the system of FIG. 1 configured as a smart wallet hub and spoke model, in accordance with embodiments of the present invention. The smart wallet hub and spoke model is a cloud-based model adopted by telco companies operating in multiple countries with similar regulatory conditions. A telco parent (i.e., the telco that is the hub in the hub and spoke model) leverages its integrated cloud infrastructure and platform to support a mobile smart wallet platform and account management system.

A cloud provider that is the telco parent manages account management 602 and regulatory adherence and banking license 604. A bank included in banks and other financial institutions 106 (see FIG. 1) manages deposit holding 606. A telco sister (i.e., a telco that is the spoke in the hub and spoke model) manages strategy and design 608 and account opening 610. The sister telco and the bank jointly manage a deposit in network 612. The sister telco manages an access to an NFC handset 614. The cloud provider (i.e., the telco parent) manages a provision of a mobile wallet application 616. The telco sister and the TSM jointly manage a provision of a pay-out network 618. In one embodiment, the TSM in FIG. 6 is TSM 110 in FIG. 1. The cloud provider manages customer intelligence 620. The telco sister manages customer care 622.

The same components in FIG. 6 describe components of other sister telco companies that are other spokes in the smart wallet hub and spoke model. The multiple sister telco companies are located in respective countries, each being subject to its own regulatory environment.

In the smart wallet hub and spoke model, the telco parent acts a cloud service provider who manages the mobile wallet application and customer intelligence at the location of the telco parent, while the account management, regulatory adherence, account opening, access to NFC handset, provision of pay-out network (i.e., payment networks, banks, and retailer coupons), and customer care is owned by the telco sister companies. Again, the telco sister companies are the spokes in the hub and spoke model. The spokes are communication routes between nodes (i.e., individual service providers such as banks, retailers, handset manufacturers, and TSM 110 (see FIG. 1)) and the hub (i.e., telco parent).

The core features of the smart wallet hub and spoke model include: (1) the telco parent located in country A provides the mobile wallet platform over a private cloud, and (2) application personalization is done by the telco sister located in country B after a local TSM pre-authorizes permission, because application loading and personalization are secured information.

In one embodiment, the telco sister obtains revenue from account opening fees, network connectivity charges, premium charges from banks, support charges, and wallet based licensing. In one embodiment, the telco sister in the smart wallet hub and spoke model obtains revenue (i.e., R) in formula (8).

R=ΣA*U+t*T*U+N*P+I*U (8)

The symbols in formula (8) are described below.

R=Revenue

A=Account opening fees

U=Number of customers

T=Transaction fees

t=Number of transactions per customer

P=Premium charges from a bank for card provisioning for an ecosystem partner

I=Interest per customer

In one embodiment, the smart wallet hub and spoke model is adopted by a telco that has an international presence and that operates in multiple countries with similar regulatory environments.

In the smart wallet hub and spoke model, the telco parent is the cloud service provider that optimizes cost and leverages shared infrastructure. In one embodiment, telco sister companies obtain revenue for application loading, personalization, interest from holding money in the bank, and account opening and provision of ecosystem partners onto smart wallets.

In one embodiment, the process flow of actions by the customer in child country B, telco in child country B, TSM in child country B, and telco in parent country A in a smart wallet hub and spoke model in which smart wallet service is provided only on a private cloud and the telco in the parent country A owns the cloud service includes the following steps:

(1) The customer in child country B places a request to open the smart wallet.

(2) The telco in child country B opens the smart wallet account.

(3) The telco in child country B allocates NFC handsets to customers.

(4) The customer in child country B receives the NFC handsets.

(5) The customer in child country B requests OTA provisioning using SMS or USSD.

(6) The telco in child country B processes the customer request OTA. The telco in child country B uses the mobile money platform over the cloud.

(7) TSM in child country B grants approval and uses Application Provider Security Domain (APSD) to initiate personalization of the application.

(8) The telco in child country B performs application loading and personalization of the application.

(9) The customer in child country B selects a product service and initiates a payment transaction.

(10) The telco in child country B initiates a payment request and connects to a payment network. The telco in child country B accesses a mobile wallet account via the telco in parent country A.

(11) In response to OTA information flow using SMS or USSD from the MNO in child country B, the payment transaction is completed.

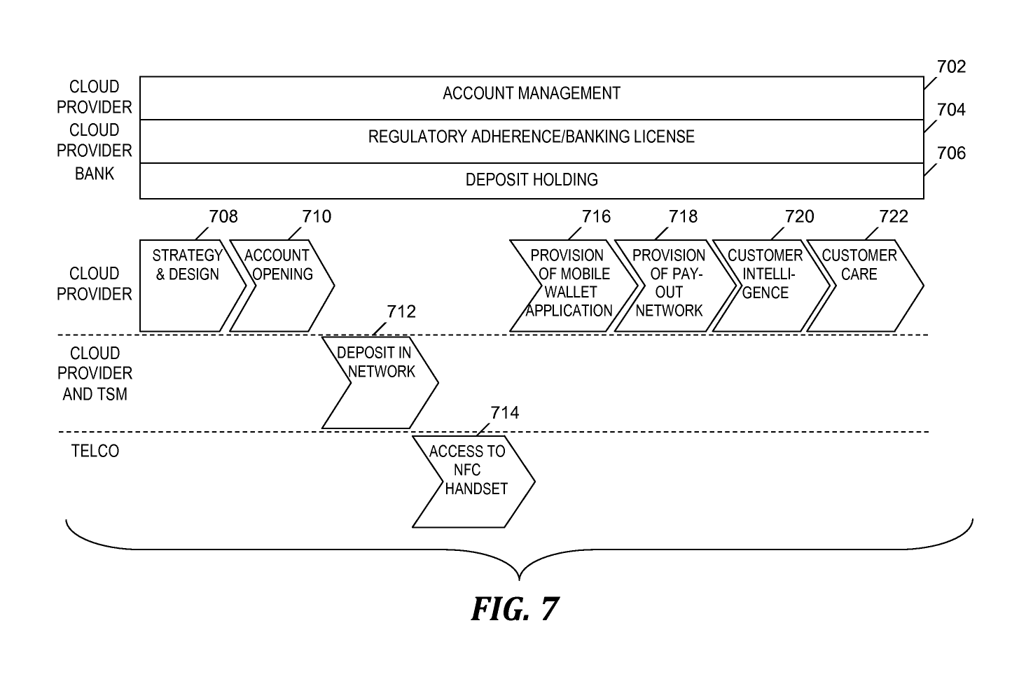

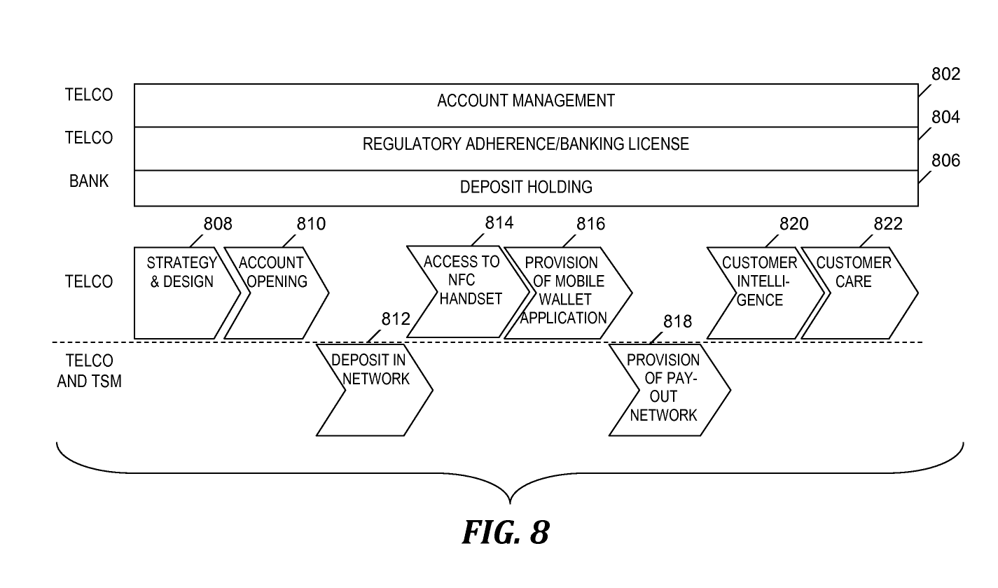

In a smart wallet aggregator model depicted in FIG. 7 and FIG. 8, a cloud service provider performs all key functions. Unlike the models depicted in FIGS. 3-6, the cloud provider performs account opening. The cloud service provider manages the customer's account, provision the customer's mobile wallet with the help of TSM 110 (see FIG. 1), and act as a proxy bank. The cloud service provider may pre-configure its smart wallet with necessary debit and credit instruments for a particular region. In the smart wallet aggregator model, the money is paid out from the smart wallet of the customer to the retailer's account and later debited from the customer's bank account. The smart wallet aggregator model is limited to micropayments only.

FIG. 7 is a block diagram of value components of the system of FIG. 1 configured as a smart wallet aggregator model, where the cloud provider and telco are different entities, in accordance with embodiments of the present invention. In the smart wallet aggregator model, most of the value chain components are owned by a cloud provider. Unlike the other models discussed above, all the transactions in the smart wallet aggregator model are debited or credited from the mobile wallet. A cloud provider that is not a telco manages account management 702 (i.e., management of customer accounts) and regulatory adherence and banking license 704. A bank included in banks and other financial institutions 106 (see FIG. 1) manages deposit holding 706. The cloud provider manages strategy and design 708 and account opening 710. The cloud provider and the TSM 110 (see FIG. 1) jointly manage a deposit in network 712. The cloud provider acts as a proxy bank. A telco manages an access to an NFC handset 714. The cloud provider manages a provision of a mobile wallet application 716, a provision of a pay-out network 718, customer intelligence 720, and customer care 722.

In the smart wallet aggregator model, the cloud provider pre-configures its smart wallet with the necessary debit and credit instruments for a region. Furthermore, the money is paid out from the mobile wallet of the customer to the retailer's account and is later debited from the customer's bank account. After the amount of money is paid, the amount is reconciled with the customer's bank.

The cloud service provider links the mobile wallet directly from different banks, and then provisions their mobile wallets to be used by retailers.

FIG. 8 is a block diagram of value components of the system of FIG. 1 configured as a smart wallet aggregator model, where a telco (i.e., MNO) is the cloud provider, in accordance with embodiments of the present invention. The telco that is the cloud provider manages account management 802 and regulatory adherence and banking license 804. A bank included in banks and other financial institutions 106 (see FIG. 1) manages deposit holding 806. The telco manages strategy and design 808 and account opening 810. The telco and the TSM 110 (see FIG. 1) jointly manage a deposit in network 812. The telco manages an access to an NFC handset 814 and a provision of a mobile wallet application 816. The telco and the TSM 110 (see FIG. 1) jointly manage a provision of a pay-out network 818. The telco manages customer intelligence 820 and customer care 822.

In the smart wallet aggregator model in which the cloud provider is a telco, the cloud provider can own the entire value chain, which is shown in FIG. 8. Thus, the telco opens a customer's account on the cloud, debits or credits from a mobile wallet, and links customer accounts to the mobile wallet. This smart wallet aggregator model in which the cloud provider is a telco only uses micro payments because mobile wallets have limited capacity for daily transactions.

Telcos and IT companies can adopt the smart wallet aggregator model, but need to acquire key business capabilities to operate the business model as the cloud provider, including (1) cloud delivery infrastructure and platform to deliver cloud services to different users; (2) cloud based account management; (3) banking license (i.e., the cloud provider must have a banking license); and (5) mobile wallet management and support which includes OTA provisioning of the mobile wallet and ecosystem partner's applications on a SIM and smart phones, respectively, and authorization from TSM 110 (see FIG. 1) to load the mobile wallet application service.

Cloud service providers in the smart wallet aggregator model obtain revenue from account opening fees, interest earned from the bank and brokerage fees from different banks' debit instruments. In one embodiment, the revenue (i.e., R) of a cloud service provider in the smart wallet as a service model is calculated by formula (9).

R=A*U*t+I*U+B*t*U (9)

The symbols used in formula (9) are described below:

R=Revenue

A=Account opening fees

U=Number of customers

B=Brokerage fees

T=Number of transactions per customer

U=Number of customers

In one embodiment, the process flow of actions by a customer, telco, cloud provider, TSM, and other ecosystem partners in a smart wallet aggregator model includes the following steps:

(1) The customer places a request to open the smart wallet.

(2) The cloud provider opens the smart wallet account, using a linking of different accounts by the other ecosystem partners and facilitation of opening the account by the TSM.

(3) The telco mirrors relevant information on NFC handsets to customers.

(4) The customer places an order or buys a good using the smart wallet.

(5) Using OTA information flow via SMS or USSD from the customer to the cloud provider, and after other ecosystem partners reconcile the smart wallet with the bank account, the cloud provider debits money from the smart wallet.

(6) The cloud provider completes the payment transaction.

Another process flow used in the smart wallet aggregator model includes the following steps:

(1) The cloud provider adds an ecosystem partner using a linking of different ecosystem partners by other ecosystem partners and facilitation of the addition of the ecosystem partner by the TSM.

(2) The telco uses an OTA link to add new retailers.

### Computer System

FIG. 9 is a block diagram of a computer that provides cloud-based services in the system of FIG. 1 and that implements the process of FIG. 2, in accordance with embodiments of the present invention. Computer 900 is a computer system that generally includes a central processing unit (CPU) 902, a memory 904, an input/output (I/O) interface 906, and a bus 908. Further, computer 900 is coupled to I/O devices 910 and a computer data storage unit 912. In one embodiment, computer 900 is a cloud computing node included in cloud computing environment 102 (see FIG. 1) and executes cloud-based components in FIG. 1, such as single sign-on tool 112 (see FIG. 1) and analytics tool 114 (see FIG. 1). In one embodiment, computer 900 is a cloud computing node included in system 100 (see FIG. 1), which is configured as a smart wallet as a service model, smart wallet in a box model, smart wallet hub and spoke model, or smart wallet aggregator model. CPU 902 performs computation and control functions of computer 900, including carrying out instructions included in program code 914 and program code 916 to perform a method of determining an optimal payment instrument, where the instructions are carried out by CPU 902 via memory 904. CPU 902 may include a single processing unit, or be distributed across one or more processing units in one or more locations (e.g., on a client and server). Program code 914 includes program code for software-based analytics tool 114 (see FIG. 1). Program code 916 includes program code for software-based single sign-on tool 112 (see FIG. 1).

Memory 904 includes a known computer readable storage medium, which is described below. In one embodiment, cache memory elements of memory 904 provide temporary storage of at least some program code (e.g., program code 914 and 916) in order to reduce the number of times code must be retrieved from bulk storage while instructions of the program code are carried out. Moreover, similar to CPU 902, memory 904 may reside at a single physical location, including one or more types of data storage, or be distributed across a plurality of physical systems in various forms. Further, memory 904 can include data distributed across, for example, a local area network (LAN) or a wide area network (WAN).

I/O interface 906 includes any system for exchanging information to or from an external source. I/O devices 910 include any known type of external device, including a display device, keyboard, etc. Bus 908 provides a communication link between each of the components in computer 900, and may include any type of transmission link, including electrical, optical, wireless, etc.

I/O interface 906 also allows computer 900 to store information (e.g., data or program instructions such as program code 914 and 916) on and retrieve the information from computer data storage unit 912 or another computer data storage unit (not shown). Computer data storage unit 912 includes a known computer-readable storage medium, which is described below. In one embodiment, computer data storage unit 912 is a non-volatile data storage device, such as a magnetic disk drive (i.e., hard disk drive) or an optical disc drive (e.g., a CD-ROM drive which receives a CD-ROM disk).

Memory 904 and/or storage unit 912 may store computer program code 914 and 916 that includes instructions that are carried out by CPU 902 via memory 904 to determine an optimal payment instrument. Although FIG. 9 depicts memory 904 as including program code 914, the present invention includes embodiments in which memory 904 does not include all of code 914 simultaneously, but instead at one time includes only a portion of code 914.

Further, memory 904 includes an operating system (not shown) and may include other systems not shown in FIG. 9.

Storage unit 912 and/or one or more other computer data storage units (not shown) that are coupled to computer 900 may include data repository 116 (see FIG. 1).

As will be appreciated by one skilled in the art, in a first embodiment, the present invention may be a system; in a second embodiment, the present invention may be a method; and in a third embodiment, the present invention may be a computer program product.

Any of the components of an embodiment of the present invention can be deployed, managed, serviced, etc. by a service provider that offers to deploy or integrate computing infrastructure with respect to determining an optimal payment instrument. Thus, an embodiment of the present invention discloses a process for supporting computer infrastructure, where the process includes providing at least one support service for at least one of integrating, hosting, maintaining and deploying computer-readable code (e.g., program code 914 and 916) in a computer system (e.g., computer 900) including one or more processors (e.g., CPU 902), wherein the processor(s) carry out instructions contained in the code causing the computer system to determine an optimal payment instrument. Another embodiment discloses a process for supporting computer infrastructure, where the process includes integrating computer-readable program code into a computer system including a processor. The step of integrating includes storing the program code in a computer-readable storage device of the computer system through use of the processor. The program code, upon being executed by the processor, implements a method of determining an optimal payment instrument.

Another embodiment of the invention provides a method that performs the process steps on a subscription, advertising and/or fee basis. That is, a service provider, such as a Solution Integrator, can offer to create, maintain, support, etc. a process of determining an optimal payment instrument. In this case, the service provider can create, maintain, support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

The present invention may be a system, a method, and/or a computer program product. The computer program product may include a computer readable storage medium (or media) (memory 904 and computer data storage unit 912) having computer readable program instructions 914 and 916 thereon for causing a processor (e.g., CPU 902) to carry out aspects of the present invention.

The computer readable storage medium (i.e., computer readable storage device) can be a tangible device that can retain and store instructions (e.g., program code 914 and 916) for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium and a computer readable storage device, as used herein, are not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions (e.g., program code 914 and 916) described herein can be downloaded to respective computing/processing devices (e.g., computer 900) from a computer readable storage medium or to an external computer or external storage device (e.g., computer data storage unit 912) via a network (not shown), for example, the Internet, a local area network, a wide area network and/or a wireless network. The network may comprise copper transmission cables, optical transmission fibers, wireless transmission, routers, firewalls, switches, gateway computers and/or edge servers. A network adapter card (not shown) or network interface (not shown) in each computing/processing device receives computer readable program instructions from the network and forwards the computer readable program instructions for storage in a computer readable storage medium within the respective computing/processing device.

Computer readable program instructions (e.g., program code 914 and 916) for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations (e.g., FIG. 2) and/or block diagrams (e.g., FIG. 1 and FIG. 9) of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions (e.g., program code 914 and 916).

These computer readable program instructions may be provided to a processor (e.g., CPU 902) of a general purpose computer, special purpose computer, or other programmable data processing apparatus (e.g., computer 900) to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium (e.g., computer data storage unit 912) that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions (e.g., program code 914 and 916) may also be loaded onto a computer (e.g. computer 900), other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

In one embodiment, memory 904 is ROM and computer 900 is a special purpose computer, where the ROM includes instructions of program code 914 and 916 that are executed by CPU 902 via ROM 904 to determine an optimal payment instrument.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method of determining an optimal payment instrument, the method comprising the steps of:
a cloud-based computer updating a database with details about funds available in multiple accounts of a customer and details about rewards provided by the multiple accounts of the customer, the accounts specifying respective payment instruments;
the computer receiving a request from a near field communication enabled mobile device to purchase an item from a retailer, the request including an identification of the retailer and an identification of the item;
based on the identifications of the retailer and the item, the computer retrieving the details about the funds and the rewards from the updated database;
based on the retrieved details about the funds and the rewards provided by the multiple accounts specifying the payment instruments, the computer applying rules and in response to the step of applying the rules, the computer determining the optimal payment instrument from among the payment instruments;
the computer initiating a display of the optimal payment instrument to the customer; and
the computer automatically selecting the displayed optimal payment instrument or receiving a manual selection of the displayed optimal payment instrument, and in response to the step of selecting or receiving the selection, the computer initiating a payment for the item by the optimal payment instrument.

2. The method of claim 1, wherein the step of updating the database includes:
the computer logging the customer into multiple systems providing the respective multiple accounts of the customer by employing a single-sign on feature of access control of the multiple systems; and
based on the customer being logged into the multiple systems by employing the single sign-on feature, the computer retrieving the details about the funds and the rewards from the multiple systems.

3. The method of claim 1, further comprising the steps of:
the computer receiving an indication of an amount of funds available in an account included in the multiple accounts and receiving authentication details from a mobile wallet being used by the customer to purchase the item;
the computer determining a cost of purchasing the item does not exceed the amount of funds; and
based on the cost of purchasing the item not exceeding the amount of funds and based on the authentication details, the computer completing an authentication of a payment for the item by the mobile wallet.

4. The method of claim 1, further comprising the steps of:
the computer determining a location of the customer by receiving a global positioning system input from the mobile device;
the computer determining the location indicates the customer is located at the retailer; and
based on the customer being located at the retailer, the computer updating the database with additional details about the rewards provided by the multiple accounts of the customer, the updating with the additional details being completed subsequent to a most recent update by the step of updating the database, wherein the step of retrieving the details about the funds and the rewards from the database includes retrieving the additional details about the rewards.

5. The method of claim 1, further comprising the steps of:
the computer receiving via the mobile device a selection by the customer to update the database subsequent to a most recent update by the step of updating the database; and
based on the receipt of the selection to update the database, the computer updating the database with additional details about the funds and the rewards provided by the multiple accounts of the customer, wherein the step of retrieving the details about the funds and the rewards from the database includes retrieving the additional details about the funds and the rewards.

6. The method of claim 1, wherein the steps of updating the database, receiving the request, retrieving the details about the rewards, applying the rules, determining the optimal payment instrument, initiating the display, selecting the displayed optimal payment instrument or receiving the selection of the displayed optimal payment instrument, and initiating the payment for the item by the optimal payment instrument are provided by the computer in a cloud-based system configured as a smart wallet as a service model, a smart wallet in a box model, a smart wallet hub and spoke model, or a smart wallet aggregator model.

7. The method of claim 1, further comprising the steps of:
the computer determining a location of the customer by receiving a global positioning system input from the mobile device;
the computer retrieving location information and payment information about one or more retailers and in response to the step of retrieving location and payment information, determining the one or more retailers are located within a threshold distance from the location of the customer and determining the one or more retailers accept payment from a mobile device enabled with near field communication; and
prior to the step of receiving the request and based on the one or more retailers located within the threshold distance from the location of the customer and accepting the payment from the mobile device enabled with near field communication, the computer determining whether a reward provided by one of the multiple accounts of the customer requires a purchase from one of the one or more retailers, and if the reward requires the purchase from one of the one or more retailers, the computer (1) updating the database with additional details about the reward subsequent to a most recent update by the step of updating the database and (2) sending a notification to the customer of the additional details about the reward.

8. The method of claim 1, further comprising the step of:
providing at least one support service for at least one of creating, integrating, hosting, maintaining, and deploying computer-readable program code in the computer, the program code being executed by a processor in the computer to implement the steps of updating the database, receiving the request, retrieving the details about the rewards, applying the rules, determining the optimal payment instrument, initiating the display, selecting the displayed optimal payment instrument or receiving the selection of the displayed optimal payment instrument, and initiating the payment for the item by the optimal payment instrument.

9. A computer program product, comprising:
a computer-readable storage device; and
a computer-readable program code stored in the computer-readable storage device, the computer-readable program code containing instructions that are executed by a central processing unit (CPU) of a computer system to implement a method of determining an optimal payment instrument, the method comprising the steps of:
the computer system updating a database with details about funds available in multiple accounts of a customer and details about rewards provided by the multiple accounts of the customer, the accounts specifying respective payment instruments, the computer system being cloud-based;
the computer system receiving a request from a near field communication enabled mobile device to purchase an item from a retailer, the request including an identification of the retailer and an identification of the item;
based on the identifications of the retailer and the item, the computer system retrieving the details about the funds and the rewards from the updated database;
based on the retrieved details about the funds and the rewards provided by the multiple accounts specifying the payment instruments, the computer system applying rules and in response to the step of applying the rules, the computer system determining the optimal payment instrument from among the payment instruments;
the computer system initiating a display of the optimal payment instrument to the customer; and
the computer system automatically selecting the displayed optimal payment instrument or receiving a manual selection of the displayed optimal payment instrument, and in response to the step of selecting or receiving the selection, the computer system initiating a payment for the item by the optimal payment instrument.

10. The computer program product of claim 9, wherein the step of updating the database includes:
the computer system logging the customer into multiple systems providing the respective multiple accounts of the customer by employing a single-sign on feature of access control of the multiple systems; and
based on the customer being logged into the multiple systems by employing the single sign-on feature, the computer system retrieving the details about the funds and the rewards from the multiple systems.

11. The computer program product of claim 9, wherein the method further comprises the steps of:
the computer system receiving an indication of an amount of funds available in an account included in the multiple accounts and receiving authentication details from a mobile wallet being used by the customer to purchase the item;
the computer system determining a cost of purchasing the item does not exceed the amount of funds; and
based on the cost of purchasing the item not exceeding the amount of funds and based on the authentication details, the computer system completing an authentication of a payment for the item by the mobile wallet.

12. The computer program product of claim 9, wherein the method further comprises the steps of:
the computer system determining a location of the customer by receiving a global positioning system input from the mobile device;
the computer system determining the location indicates the customer is located at the retailer; and
based on the customer being located at the retailer, the computer system updating the database with additional details about the rewards provided by the multiple accounts of the customer, the updating with the additional details being completed subsequent to a most recent update by the step of updating the database, wherein the step of retrieving the details about the funds and the rewards from the database includes retrieving the additional details about the rewards.

13. The computer program product of claim 9, wherein the method further comprises the steps of:
the computer system receiving via the mobile device a selection by the customer to update the database subsequent to a most recent update by the step of updating the database; and
based on the receipt of the selection to update the database, the computer system updating the database with additional details about the funds and the rewards provided by the multiple accounts of the customer, wherein the step of retrieving the details about the funds and the rewards from the database includes retrieving the additional details about the funds and the rewards.

14. The computer program product of claim 9, wherein the steps of updating the database, receiving the request, retrieving the details about the rewards, applying the rules, determining the optimal payment instrument, initiating the display, selecting the displayed optimal payment instrument or receiving the selection of the displayed optimal payment instrument, and initiating the payment for the item by the optimal payment instrument are provided by the computer system configured as a smart wallet as a service model, a smart wallet in a box model, a smart wallet hub and spoke model, or a smart wallet aggregator model.

15. A computer system comprising:
a central processing unit (CPU);
a memory coupled to the CPU; and
a computer-readable storage device coupled to the CPU, the storage device containing instructions that are executed by the CPU via the memory to implement a method of determining an optimal payment instrument, the method comprising the steps of:
the computer system updating a database with details about funds available in multiple accounts of a customer and details about rewards provided by the multiple accounts of the customer, the accounts specifying respective payment instruments, the computer system being cloud-based;
the computer system receiving a request from a near field communication enabled mobile device to purchase an item from a retailer, the request including an identification of the retailer and an identification of the item;
based on the identifications of the retailer and the item, the computer system retrieving the details about the funds and the rewards from the updated database;
based on the retrieved details about the funds and the rewards provided by the multiple accounts specifying the payment instruments, the computer system applying rules and in response to the step of applying the rules, the computer system determining the optimal payment instrument from among the payment instruments;
the computer system initiating a display of the optimal payment instrument to the customer; and
the computer system automatically selecting the displayed optimal payment instrument or receiving a manual selection of the displayed optimal payment instrument, and in response to the step of selecting or receiving the selection, the computer system initiating a payment for the item by the optimal payment instrument.

16. The computer system of claim 15, wherein the step of updating the database includes:
the computer system logging the customer into multiple systems providing the respective multiple accounts of the customer by employing a single-sign on feature of access control of the multiple systems; and
based on the customer being logged into the multiple systems by employing the single sign-on feature, the computer system retrieving the details about the funds and the rewards from the multiple systems.

17. The computer system of claim 15, wherein the method further comprises the steps of:
the computer system receiving an indication of an amount of funds available in an account included in the multiple accounts and receiving authentication details from a mobile wallet being used by the customer to purchase the item;
the computer system determining a cost of purchasing the item does not exceed the amount of funds; and
based on the cost of purchasing the item not exceeding the amount of funds and based on the authentication details, the computer system completing an authentication of a payment for the item by the mobile wallet.

18. The computer system of claim 15, wherein the method further comprises the steps of:
the computer system determining a location of the customer by receiving a global positioning system input from the mobile device;
the computer system determining the location indicates the customer is located at the retailer; and
based on the customer being located at the retailer, the computer system updating the database with additional details about the rewards provided by the multiple accounts of the customer, the updating with the additional details being completed subsequent to a most recent update by the step of updating the database, wherein the step of retrieving the details about the funds and the rewards from the database includes retrieving the additional details about the rewards.

19. The computer system of claim 15, wherein the method further comprises the steps of:
the computer system receiving via the mobile device a selection by the customer to update the database subsequent to a most recent update by the step of updating the database; and
based on the receipt of the selection to update the database, the computer system updating the database with additional details about the funds and the rewards provided by the multiple accounts of the customer, wherein the step of retrieving the details about the funds and the rewards from the database includes retrieving the additional details about the funds and the rewards.

20. The computer system of claim 15, wherein the steps of updating the database, receiving the request, retrieving the details about the rewards, applying the rules, determining the optimal payment instrument, initiating the display, selecting the displayed optimal payment instrument or receiving the selection of the displayed optimal payment instrument, and initiating the payment for the item by the optimal payment instrument are provided by the computer system configured as a smart wallet as a service model, a smart wallet in a box model, a smart wallet hub and spoke model, or a smart wallet aggregator model.
